(19) United States
(12) Patent Application Publication
(10) Pub. No.: US 2021/0264450 A1
(43) Pub. Date: Aug. 26, 2021

(54) SYSTEM AND METHOD TO GENERATE DIGITAL RESPONSES TO A CUSTOMER QUERY

(71) Applicant: PM Labs, Inc., Walnut, CA (US)

(72) Inventors: Arjun Maheswaran, Bangalore (IN); Akhilesh Sudhakar, Chennai (IN)

(73) Assignee: PM Labs, Inc.

(21) Appl. No.: 16/801,422

(22) Filed: Feb. 26, 2020

(51) Int. Cl. G06Q 30/02; G06Q 30/00; G06K 9/62; H04L 12/58

(52) U.S. Cl. CPC G06Q 30/0203; H04L 51/02; G06K 9/6256; G06Q 30/016

(57) ABSTRACT

A system to generate digital responses to the customer query is disclosed. The system includes a customer interaction subsystem to receive one or more customer queries from a customer. The system also includes a multitask profiler subsystem operatively coupled to the customer interaction subsystem. The multitask profiler subsystem generates at least three human readable profiles and at least three machine-readable profiles based on the one or more customer queries. The system further includes a profile mapping subsystem operatively coupled to the multitask profiler subsystem. The profile mapping subsystem stores relation of each of the at least three machine readable profiles with each other.

### BACKGROUND

Embodiment of a present disclosure relates to customer product assistance and more particularly to a system and a method to generate digital response to a customer query.

Conventional customer support systems rely upon a customer service representative to field questions about a product and provide a solution using channels for communications such as phone, e-mail and web-based FAQs. Some systems may offer systems to assist the customer support representative in diagnosing the problem with pre-assembled potential solutions. Other conventional systems provide an automated menu-based support system that the customer navigates through online or over-the-phone interactions. However, such a conventional system requires significant time and expense. Moreover, such systems require a significant outlay of distributed computing resources and manpower for each customer and corresponding devices for assistance.

Furthermore, advancements in artificial intelligence technology and natural language processing have led to a variety of innovations in providing automated responses to digital questions of individual customers. For example, automated chat systems are now able to analyse a digital question of a customer to identify content cues that the systems use to generate an automated digital message in response to the digital question from the customer. However, despite such advances, the automated chat systems continue to suffer from a plurality of disadvantages, particularly in the accuracy, efficiency and flexibility of generating responses to queries from individual customers. For example, such chat systems often have difficulty in generating and providing appropriate responses to a variety of categories of products for digital questions regarding different topics. More particularly, such systems may provide an accurate digital response to a digital question regarding a first category but provide an irrelevant digital response to a digital question regarding another category as they are trained to provide accurate answers for a particular category of products.

Hence, there is a need for an improved system and method to generate digital responses to a customer query to address the aforementioned issue(s).

### BRIEF DESCRIPTION

In accordance with an embodiment of a present disclosure, a system to generate digital responses to a customer query is provided. The system includes a customer interaction subsystem configured to receive one or more customer queries from a customer. The system also includes a multitask profiler subsystem operatively coupled to the customer interaction subsystem. The multitask profiler subsystem is configured to generate at least three human readable profiles and at least three machine-readable profiles based on the one or more customer queries. The system further includes a profile mapping subsystem operatively coupled to the multitask profiler subsystem. The profile mapping subsystem is configured to store relation of each of the at least three machine readable profiles with each other.

In accordance with another embodiment of the present disclosure, a method to generate digital responses to a customer query is provided. The method includes receiving, by a customer interaction subsystem, one or more customer queries from a customer. The method also includes generating, by a multitask profiler subsystem, at least three human readable profiles and at least three machine-readable profile based on the one or more customer queries. The method further includes storing, by a profile mapping subsystem, relation of each of the at least three machine readable profiles with each other.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to generate digital responses to a customer query in accordance with an embodiment of the present disclosure;

FIG. 2 is a block diagram representation of an exemplary system to generate digital responses to the customer query in accordance with an embodiment of the present disclosure;

FIG. 3 is a block diagram of a computer or a server in accordance with an embodiment of the present disclosure; and

FIG. 4 is a flow chart representing the steps involved in a method to generate digital responses to the customer query in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and method to generate digital responses to the customer query. The system includes a customer interaction subsystem to receive one or more customer queries from a customer. The system also includes a multitask profiler subsystem operatively coupled to the customer interaction subsystem. The multitask profiler subsystem generates at least three human readable profiles and at least three machine-readable profiles based on the one or more customer queries. The system further includes a profile mapping subsystem operatively coupled to the multitask profiler subsystem. The profile mapping subsystem stores relation of each of the at least three machine readable profiles with each other.

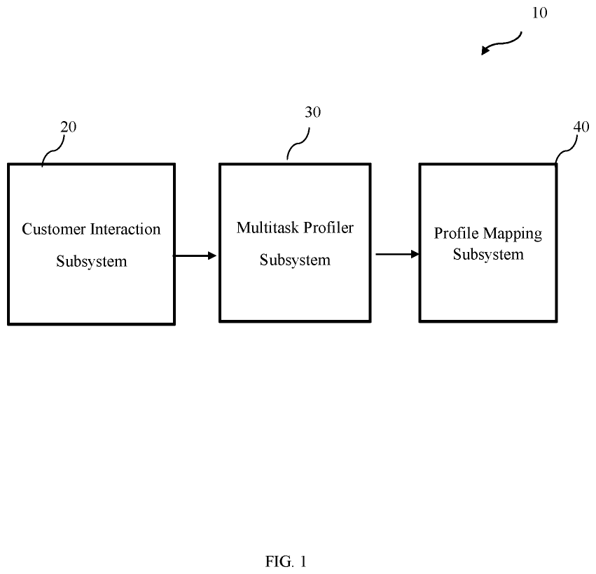

FIG. 1 is a block diagram representation of a system 10 to generate one or more digital responses to one or more customer queries in accordance with an embodiment of the present disclosure. The system 10 includes a customer interaction subsystem 20 which receives the one or more customer queries from a customer. In one embodiment, the customer may use a customer interface device such as a mobile phone or a computer to share the one or more customer queries with the customer interaction subsystem. In such embodiment, the mobile phone may include an interface which may execute functions locally in the mobile phone or at server. In another embodiment, the customer may access the computer such as a desktop, laptop, tablet, or other computational device. In some embodiments, the customer interface device may be connected to a network. In one embodiment, the customer interface device may be connected to the network via a wired connection. In another embodiment, the customer interface device may be connected to the network via a wireless connection. In a specific embodiment, the customer may interact with the customer interaction subsystem via the network to share the one or more queries in a form of email, short messaging service, a text of a chat session or a web content for example, a comment or post on a social media platform, a voice call, a voice message or the like. Hence, the one or more customer queries corresponds to text or voice of the customer interaction with the system 10. The voice call or the voice message may be converted into text using multiple voice to text conversion techniques.

In one embodiment, the system 10 may access data from a database (not shown in FIG. 1). The database is composed of training data. The training data includes proprietary data. The proprietary data is data that is owned and controlled by an individual, an organization or a group. The proprietary data may include issues related to the products. The training data also includes public data which is accessible to public. The training data may include augmented data which is a combination of proprietary data and the public data. Such training data may be in the form of structured or unstructured data. In some embodiments, the training data is analysed using a natural language processing model which uses a machine learning model. Once the models are trained, the trained models are applied on the real time queries of the customer.

Subsequently, the system 10 further includes a multitask profiler subsystem 30 operatively coupled to the customer interaction subsystem 20. The multitask profiler subsystem 30 generates at least three human readable profiles and at least three machine-readable profiles based on the one or more customer queries. As used herein, the machine-readable profile is a profile which is created based on the one or more customer queries and whose content may be readily processed by computers. The machine-readable profile includes sufficient structure to provide the necessary context to support the processes for which they are created. Similarly, the human-readable profile is a representation of data or information that may be naturally read by humans. The human-readable profile is often encoded Unicode text, rather than presented in a binary representation.

In one embodiment, the at least three machine-readable profiles may include a machine-readable customer profile, a machine-readable product profile and a machine-readable issue profile. Similarly, the at least three human readable profiles may include a human readable customer profile, a human readable product profile and a human readable issue profile. In a specific embodiment, the machine-readable customer profile and the human readable customer profile may include at least one of personal details of the customer, products associated with the customer and the like. In another specific embodiment, the machine-readable product profile and the human readable product profile may include at least one of product details such as product details and specifications, merchant details and the like. In yet another specific embodiment, the issue profile may include the type of issues associated with a product. In one embodiment, the at least three machine readable profiles may be converted into the corresponding at least three human readable profiles using one or more conversion techniques.

Upon generating the at least three machine readable profiles and the at least three human readable profiles, the multitask profiler subsystem identifies the relation between the machine-readable customer profile, the machine-readable product profile and the machine-readable issue profile by multiple mathematical operations on the at least three machines.

Moreover, the system 10 includes a profile mapping subsystem 40 operatively coupled to the multitask profiler subsystem 30. The profile mapping subsystem 40 stores the relation between the machine-readable customer profile, the machine-readable product profile and the machine-readable issue profile. In one embodiment, the relation between the machine-readable customer profile, the machine-readable product profile and the machine-readable issue profile may be derived from a contextual embedding layer. The contextual embedding layer assigns contextual mathematical representation to each of the at least three machine readable profiles, wherein the representation carries information of the context. The contextual embedding layer provides domain specific learning which helps to assign domain and context specific contextual mathematical representation to each of the at least three machine readable profiles.

In one embodiment, the system 10 may include an assistance engine (not shown in FIG. 1) operatively coupled the multitask profiler subsystem and the profile mapping subsystem. The assistance engine generates one or more responses for a digital assistance to respond to the one or more customer queries based on relation between the at least three machine readable profiles and the at least three human readable profiles stored. In such an embodiment, the relation is generated upon mapping the at least three machine profiles and a historic assistance action. The historic assistance action may include historic customer queries and corresponding communication resolutions, feedback and comments.

The historic customer queries are converted to obtain corresponding machine-readable profiles and such machine-readable profiles are compared with the machine-readable profile of the current customer query. Upon comparison, the historic machine-readable profile which is closest to the machine-readable profile of the current customer query is selected and a corresponding historic assistance action is retrieved and is adapted to generate the response for the current customer query. Further, the digital assistant's actions are stored in the database which may be used as historic assistance actions for the future customer queries. In some embodiments, the digital assistant's action is stored after approval of the human agent and/or modified by the human agent. As used herein, the digital assistant is an intelligent virtual assistant or intelligent personal assistant that may perform tasks or services for an individual based on commands or questions. Sometimes, the term chatbot is used to refer to virtual assistants generally or specifically accessed by online chat. In one embodiment, the response generated by the digital assistant may be directly used to provide the response to the customer query. In another embodiment, the response generated by the digital assistant may be provided to a human agent to respond to the customer query.

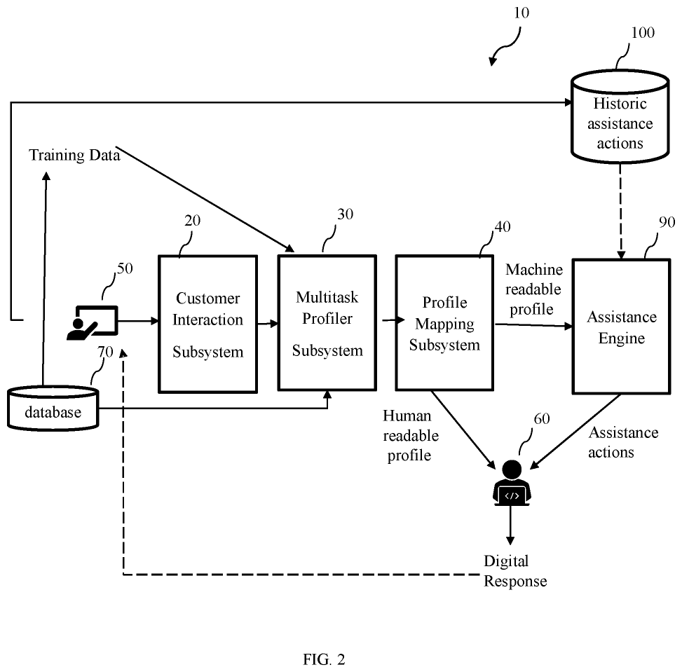

FIG. 2 is a block diagram representation of an exemplary system 10 to generate digital responses to the customer query in accordance with an embodiment of the present disclosure. Considering an example where a customer 50, during a chat session with a digital assistant 60 on a website of e-commerce based ‘xyz’ company, posted a query that “T-shirt of ‘abc’ brand for size ‘medium’ has fitting issue” which the customer 50 has brought from the ‘xyz’ company. Here, in this example, the digital assistant is a chatbot. The customer interaction subsystem 20 of the system 10 receives the text of such query and store the query in the database 70. Furthermore, the multitask profiler subsystem 30 generates a machine-readable profile and a human readable profile. The multitask profiler subsystem 30 applies the trained machine learning models and natural language processing models on the customer query to identify context of the query. Based on the context of the query, the multitask profiler subsystem 30 identifies the product and the issue from the customer query. Also, the multitask profiler subsystem 30 generates customer profile based on customer query received by the customer interaction subsystem 20.

Moreover, the multitask profiler subsystem 30 of the system 10 generates at least three machine readable profiles such as a machine-readable customer profile, a machine-readable product profile and a machine-readable issue profile based on the identified product, issues and customer profile. Similarly, the multitask profiler subsystem 30 generates at least three human readable profiles such as a human readable customer profile, a human readable product profile and a human readable issue profile based on the identified product, issues and customer profile.

Consequently, the profile mapping subsystem 40 of the system 10 identifies the relation between the machine-readable customer profile, the machine-readable product profile and the machine-readable issue profile based on the identified product, issues and customer profile and store such relation. Further, based on a contextual embedding layer, the profile mapping subsystem 40 searches in the database 70 that whether there are any such historic interactions that occurred in similar contexts. Based on the identification of the similar interactions, the system 10 identifies that many customers have posted that they are facing issues with fitting a T-shirt of ‘abc’ brand in size ‘medium’. Upon identification of the correct problem, the assistance engine 90 searches for the response which was earlier given to the different customers on the similar query. Hence, the assistance engine 90 generates a digital response for the digital assistant 60 to respond to the customer 50 based on a human readable profile, a machine-readable profile and the historic assistance actions 100 such as previous given solution to the same problem. Further, the digital assistant 60 provides the response to the customer 50 that “replace the product and try for other sizes”. Therefore, the digital assistant 60 is able to provide the correct solution of the problem as the profile mapping subsystem 40 has identified the problem correctly based on the contextual embedding layer result.

Considering another example where a customer 50, during a course of conversation with a digital assistant 60 on a website of e-commerce-based company, posted a query that “lipstick of brand ‘xyz’ is melting at a faster rate even at a room temperature”. The digital assistant in such example is conversational agent which uses natural language processing (NLP) to understand, analyse, and create meaning from human language. As described in the aforementioned example, the profile mapping subsystem 40 identifies the relation between the machine-readable customer profile, the machine-readable product profile and the machine-readable issue profile based on the identified product, issues and customer profile and store such relation. Further, the profile mapping subsystem 40 searches in the database 70 that whether there are any such historic interactions that occurred in similar contexts. Based on the identification of the similar interactions, the system 10 identifies that many customers have posted that they are facing similar issues with lipstick of some other brand such as ‘efg’ brand. Upon identification of the correct problem (melting of lipstick), the assistance engine 90 searches for the response which was earlier given to the different customers on issues related to lipstick of ‘efg’ brand. Hence, the assistance engine 90 generates a digital response for the digital assistant 60 to respond to the customer 50 based on a human readable profile, a machine-readable profile and the historic assistance actions 100 such as previous given solution to the same problem. The assistant engine 90, stores the digital assistant's action after approval of the human agent and/or modified by the human agent. Further, the digital assistant 60 provides the response to the customer 50 that “return the lipstick with another piece and refund for the same will be initiated soon”.

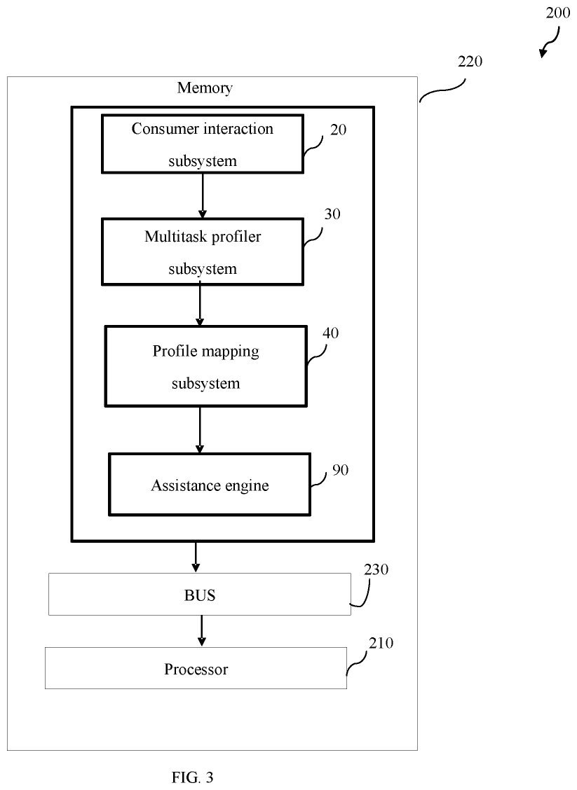

FIG. 3 is a computer or a server 200 in accordance with an embodiment of the present disclosure. The server includes processor(s) 210, and memory 220 operatively coupled to the bus 230. The processor(s) 210, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 220 includes a plurality of subsystems stored in the form of executable program which instructs the processor 210 to perform the method steps illustrated in FIG. 1. The memory 220 has following subsystems: a customer interaction subsystem 20, a multitask profiler subsystem 30, a profile mapping subsystem 40 and an assistance engine 90.

The memory 220 includes a customer interaction subsystem 20 receives one or more customer queries from a customer. The memory 220 also includes a multitask profiler subsystem 30 operatively coupled to the customer interaction subsystem 20. The multitask profiler subsystem 30 generates at least three human readable profiles and at least three machine-readable profiles based on the one or more customer queries. The memory 220 further includes a profile mapping subsystem 40 operatively coupled to the multitask profiler subsystem 30. The profile mapping subsystem 40 stores relation of each of the at least three machine readable profiles with each other in a contextual embedding layer. In one embodiment, the memory 220 may include an assistance engine 90 operatively coupled to the profile mapping subsystem 40 and the multitask profiler subsystem 30. The assistance engine 90 generates the one or more digital responses for a digital assistant to respond to the one or more customer queries based on one or more assistance actions and the at least three human readable profile. In such embodiment, the one or more assistance actions corresponds to a historic assistance action and the at least three machine-readable profile.

Computer memory 220 elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) 210.

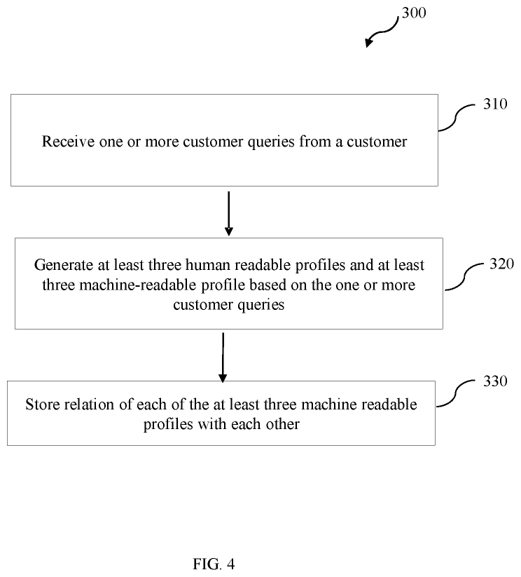

FIG. 4 is a flow chart representation of a method 300 to generate digital responses to a customer query in accordance with an embodiment of the present disclosure. The method 300 includes receiving one or more customer queries from a customer in step 310. In one embodiment, receiving the one or more customer queries from the customer may include receiving the one or more customer queries from the customer using a customer interaction subsystem. In some embodiments, the one or more customer queries are representative of text of customer interaction. In such embodiment, the text of customer interaction may include text of a chat session, web content (for example, comments or post on the social media platform), email, short messaging service content, a voice call or a voice message or the like.

Furthermore, the method 300 includes generating at least three human readable profiles and at least three machine-readable profile based on the one or more customer queries in step 320. In one embodiment, generating the at least three human readable profiles and the at least three machine-readable profiles based on the one or more customer queries may include generating the at least three human readable profiles and the at least three machine-readable profile based on the one or more customer queries using a multitask profiler subsystem. In some embodiments, generating the at least three human readable profiles may include generating a human readable customer profile, a human readable product profile and a human readable issue profile. In another embodiment, generating the at least three machine readable profiles may include generating a machine-readable customer profile, a machine-readable product profile and a machine-readable issue profile.

Moreover, the method 300 includes storing relation of each of the at least three machine readable profiles with each other in a contextual embedding layer in step 330. In one embodiment, storing relation of each of the at least three machine readable profiles with each other may include storing relation of each of the at least three machine readable profiles with each other using profile mapping subsystem.

In one embodiment, the method 300 may include generating the one or more digital responses for a digital assistant to respond to the one or more customer queries based on one or more assistance actions and the at least three human readable profile. In such embodiment, generating the one or more digital responses for a digital assistant to respond to the one or more customer queries based on one or more assistance actions and the at least three human readable profile using an assistance engine. In a specific embodiment, the one or more assistance actions corresponds to a historic assistance action and the at least three machine-readable profile. In some embodiments, the historic assistance action may include previous communication resolutions, feedback and comments corresponding to the customer.

In an exemplary embodiment, generating the one or more digital responses for the digital assistant to respond to the one or more customer queries may include generating the one or more digital responses in a form of text of a chat session, web content, email or short messaging service content, voice call or voice message. In some embodiments, the historic assistance actions are derived based on training data, wherein the training data may include proprietary data, public data and augmented data.

Various embodiments of the system and method to generate digital responses to the customer query described above enables an end to end intelligent digital assistant that efficiently and flexibly provides accurate digital responses to digital queries. The system and method provide improved conversation driven correct problem identification and ability to serve pointed and accurate information preferably generated in response to the customer query

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to generate one or more digital responses to one or more customer queries comprising:
a customer interaction subsystem configured to receive one or more customer queries from a customer;
a multitask profiler subsystem operatively coupled to the customer interaction subsystem, wherein the multitask profiler subsystem is configured to generate at least three human readable profiles and at least three machine-readable profiles based on the one or more customer queries; and
a profile mapping subsystem operatively coupled to the multitask profiler subsystem, wherein the profile mapping subsystem is configured to store relation of each of the at least three machine readable profiles with each other.

2. The system of claim 1, wherein the one or more customer queries comprises text or voice of customer interaction.

3. The system of claim 1, wherein the at least three machine-readable profiles comprises a machine-readable customer profile, a machine-readable product profile and a machine-readable issue profile.

4. The system of claim 1, wherein the at least three human readable profiles comprises a human readable customer profile, a human readable product profile and a human readable issue profile.

5. The system of claim 1, further comprising an assistance engine operatively coupled to the profile mapping subsystem and the multitask profiler subsystem, wherein the assistance engine is configured to generate the one or more digital responses for a digital assistant to respond to the one or more customer queries based on relation of each of the at least three machine readable profiles with each other.

6. The system of claim 5, wherein the relation comprises mapping of a historic assistance action and the at least three machine-readable profiles.

7. The system of claim 6, wherein the historic assistance actions are derived based on training data, wherein the training data comprises proprietary data, public data and augmented data.

8. The system of claim 5, wherein the one or more digital responses comprises text of a chat session, web content, email, a voice call or a voice message or short messaging service content.

9. A method comprising:
receiving, by a customer interaction subsystem, one or more customer queries from a customer;
generating, by a multitask profiler subsystem, at least three human readable profiles and at least three machine-readable profiles based on the one or more customer queries; and
storing, by a profile mapping subsystem, relation of each of the at least three machine readable profiles with each other.

10. The method of claim 9, further comprising generating, by an assistance engine, the one or more digital responses for a digital assistant to respond to the one or more customer queries based on relation of each of the at least three machine readable profiles with each other.

11. The method of claim 10, wherein generating the one or more digital responses for a digital assistant to respond to the one or more customer queries by mapping relation between a historic assistance action and the at least three machine-readable profiles.
